(19) United States
(12) Patent Application Publication
(10) Pub. No.: US 2004/0190015 A1
(43) Pub. Date: Sep. 30, 2004

(54) Print system and print thumbnail creating method for output image of markup language

(76) Inventor: Takashi Uchida, Ogori-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/749,549

(22) Filed: Jan. 2, 2004

(30) Foreign Application Priority Data
Jan. 7, 2003 (JP) P.2003-000951

(51) Int. Cl. G06F 15/00

(52) U.S. Cl. 358/1.6; 358/1.15

(57) ABSTRACT

An STB to which a printer is connected includes: a transceiver for receiving from outside a display content and thumbnail data for checkup of a print image or a print content where the link destination of the thumbnail data is indicated; a display data generator for generating display data used to display a display content on a TV; a remote control for inputting a print image and a print instruction; a content analyzer for analyzing a print content; and a print data output section for outputting the print content on a printer based on an instruction from the remote control.

### CROSS REFERENCE TO RELATED APPLICATION

This application is based upon and claims the benefit of priority of Japanese Patent Application No. 2003-951 filed on Jan. 7, 2003, the contents of which are incorporated herein by reference in its entirety.

### BACKGROUND OF THE INVENTION

The present invention relates to a print system and a print thumbnail creating method for an output image of a markup language.

In recent years, as television broadcasts go into digital broadcasting, the users have been enjoying a variety of services in the home. Among theses services, in case it is expected that the user will later check a service such as home shopping, mail distribution and timetable assistance and related information, it is more often convenient for the user to keep at hand list of commodities and a printout of received mail once the user has confirmed the details of the information the user desired. Thus, in case information received from a broadcast station is printed on a printer, it is expected that the printer is connected to for example an STB (set-top box) including an interface such as one for the IEEE1394 bus.

Broadcast contents distributed over the aforementioned television broadcasts are described using a markup language such as the HTML (Hyper Text Markup Language) and BML (Broadcast Markup Language). Each file in a broadcast content described using such a language is turned into an object by way of the DOM (Document Object Model) as a general API (Applications Programming Interface) and passed to an application program. Thus, a content on the Internet can be incorporated into a television broadcast without special processing.

In case a print content for output on a printer is described in such a broadcast content, it is natural that a markup language is used in the same way.

Such a markup language is displayed by way of a Web browser operating on a host unit such as a PC. Some techniques create HTML document data as a thumbnail image (for example, refer to FIG. 11, page 9, the Japanese Patent Laid-Open No. 2001-166979).

A document processing unit and a document display unit described in the Japanese Patent Laid-Open No. 2001-166979 aim at simultaneously browsing an original document and a document specified by an URL described in the original document and comprises an URL detector for detecting the description of a URL for acquiring other information from the document, an information acquisition section for acquiring the corresponding information via a communications line based on the description detected by the URL detector, a thumbnail creation section for creating a thumbnail from the information acquired by the information acquisition section, and a document processor for inserting the information indicating the thumbnail created by the thumbnail creation section to process a document.

The units described in the Japanese Patent Laid-Open No. 2001-166979 address thumbnail data in a display content aiming at simultaneously browsing an original document and the document specified by an URL described in the original document. Thus, in case a display content is different from an output content such as in a broadcast content, the thumbnail data does not belong to the same content and have the same layout as the print image, so that the thumbnail data cannot be an print image.

The STB is a unit for displaying a received broadcast content on a television receiver so that it does not have a mechanism such as a printer driver, unlike a host terminal such as a PC which is a platform for various software applications. The printer driver is a software application provided per printer and equipped with a control function specific to a printer. While an output image is obtained by introducing a printer driver, its introduction into an STB results in a greater size of the STB.

### SUMMARY OF THE INVENTION

An object of the invention is to provide a print system comprising a printer and a receiver, the print system capable of acquiring a print image even on a receiver without a printer driver system and facilitating checkup of a print layout.

A print system according to the invention is a print system comprising a printer and a receiver, characterized in that the receiver comprises: receiving means for receiving thumbnail data as a print image from the printer and related information indicating the link destination of the thumbnail data; display means for displaying the related data; instruction input means for inputting a print instruction for the related data; and a transfer means for transferring a data file pointed at by the thumbnail data in accordance with the link when the print instruction is received by the instruction input means.

According to the invention, even a receiver which is not equipped with a printer driver can acquire a print image thus facilitating checkup of the print layout.

### BRIEF DESCRIPTION OF THE DRAWINGS

FIG. 1 is a functional block diagram showing the configuration of a print system according to Embodiment 1 of the invention;

FIG. 2 is a functional block diagram showing the configuration of a print system according to Embodiment 2 of the invention;

FIG. 3 is a flowchart of content/operation processing in the print system shown in FIG. 1;

FIG. 4 is a flowchart of content/processing in the print system shown in FIG. 2;

FIG. 5 is a flowchart of the processing of thumbnail creation in a host terminal such as a distribution server in the print system according to Embodiment 1 of the invention;

FIG. 6 is a processing flowchart of thumbnail display in the STB according to Embodiment 1of the invention; and

FIG. 7 is a flowchart showing the processing of extracting a thumbnail file from an external storage such as a PC card in the STB according to Embodiment 2 of the invention to display the thumbnail.

### DETAILED DESCRIPTION OF THE PREFERRED EMBODIMENTS

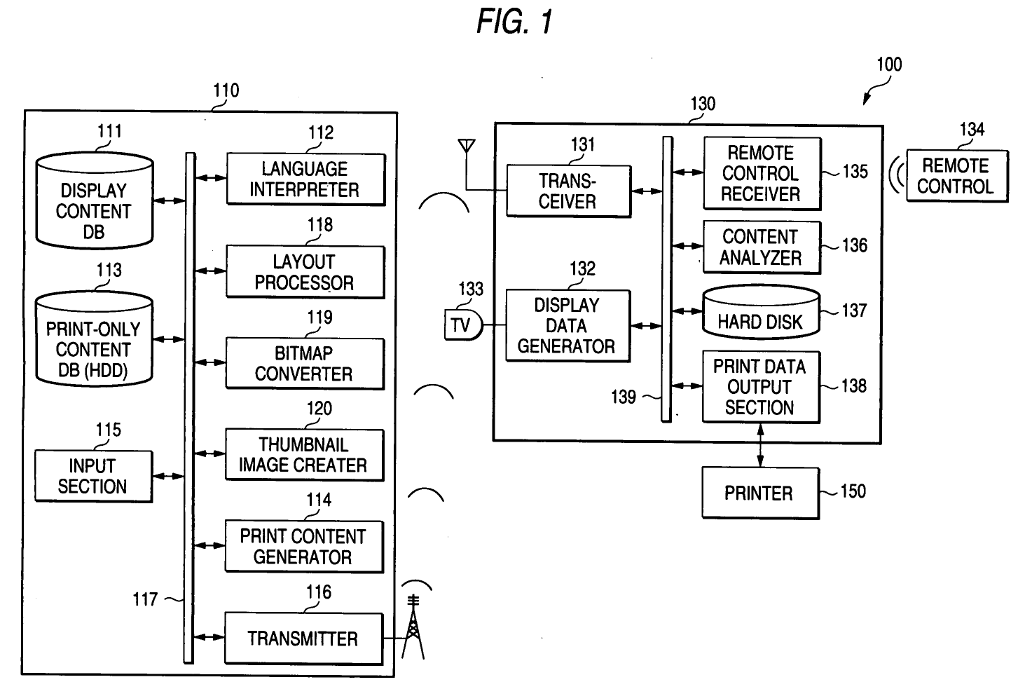

Embodiments of the invention are detailed below referring to FIGS. 1 through 6.

### Embodiment 1

FIG. 1 is a functional block diagram showing the configuration of a print system 100 according to Embodiment 1 of the invention. The print system 100 according to this embodiment receives on an STB 130 at home a print-only content which is not displayed on a television set thumbnail tag-attached data and a thumbnail file transmitted from a distribution server 110 of a broadcast station. The print system 100 then receives a markup language including a thumbnail tag and a thumbnail file as a print-only content from the STB 130, interprets the markup language, acquires a thumbnail image from the link destination indicated by the thumbnail tag and an attached file, and transfers the thumbnail image to a display unit. The print-only content refers to a content used exclusively for printing which is not displayed on a TV 133.

The distribution server 110 is provided in a television broadcast station. The distribution server 110 generates a broadcast content as a print-only content to which a thumbnail data tag for a print image and a thumbnail file are attached and transmits as a data broadcast the broadcast content generated to each home. Roughly speaking, the distribution server 110 comprises two DBs (Databases), a display content DB 111 and a print-only content DB 113, and two processors including a CPU, a print content generator 114, an input device 115 and a transmitter 116.

The display content DB 111 retains a previously created display content. The print content DB 113 retains a print-only content generated by the print content generator 114.

The print content generator 114 transfers a display content retained in the DB to a language interpreter 112 in accordance with an input from the operator in order to request interpretation of the language. The language interpreter 112 interprets the display content and transfers the interpreted data to a layout processor 118 for layout of a print image. The print image laid out is transferred to a bitmap converter 119, which converts the print image to bitmap data and transfers the bitmap data to a thumbnail image creating section 120.

The thumbnail image creating section 120 converts the bitmap data generated by the bitmap converter 119 so that the data volume will be reduced and the resolution will be scaled down, and transfers the resulting data to the print content generator 114. The print content generator 114 stores file information on a thumbnail image generated by the bitmap converter 119 into a special tag for a print content which does not display the image. The print content generator 114 attaches a thumbnail file to the content to create a print content.

The input device 115 comprises operation sections (not shown) such as a keyboard, a mouse and a remote control and inputs a signal obtained by the operation of the operator on the operation sections. The transmitter 116 converts the generated broadcast content into a transmission format and performs television broadcasts in accordance with a communications protocol stipulated by the standards. A bus 117 is a parallel data transmission path in the distribution server 110.

The STB 130 is a communications terminal. The STB 130 comprises an image processing function for storing into a hard disk (HDD) 137 a display content and a print-only content included in a broadcast content received and displaying the content data on the TV 133 or outputting the content data on a printer 150 in accordance with a print instruction input from a remote control 134, an information processing function, and a user interface function.

The STB 130 comprises the hard disk 137, five processors implemented by CPUs, a transceiver 131, a display data generator 132, a remote control receiver 135, a content analyzer 136 and a print data output section 138, a bus 139 for transmitting data between these processors, and a TV (Television) 133 and a remote control 134. The hard disk 137 is a storage for retaining a broadcast content received from the distribution server 110.

The transceiver 131 receives a television broadcast wave to extract a broadcast content and stores the files included in the extracted broadcast content to corresponding directories of the hard disk 137 specified as per the communication protocol for data broadcasts. The transceiver 131 may be formed by a transmitter and a receiver that are separately provided. Further, the transceiver 131 maybe shared with another apparatus. The content analyzer 136 analyzes the thumbnail tag included in the print-only content and pulls a file from the file information included in the thumbnail tag to extract thumbnail data. The content analyzer 136 transfers the extracted thumbnail data to the display data generator 132 to generate display data used to drive the TV 133.

The TV 133 is a television set comprising only a display function implemented by a CRT, a PDP or an LCDP, and displays display data generated by the display data generator 132. The remote control 134 supplies an input such as a print instruction by the user's operation to the remote control receiver 135 by way of infrared rays. The remote control receiver 135 accepts the input from the remote control 134.

The print data output section 138 reads a print-only content from the hard disk 137 in accordance with the print output instruction from the browser in response to an input from the remote control receiver 135 and outputs the print-only content to the printer 150. The bus 139 is a parallel data transmission path for communicating data between the sections in the STB 130.

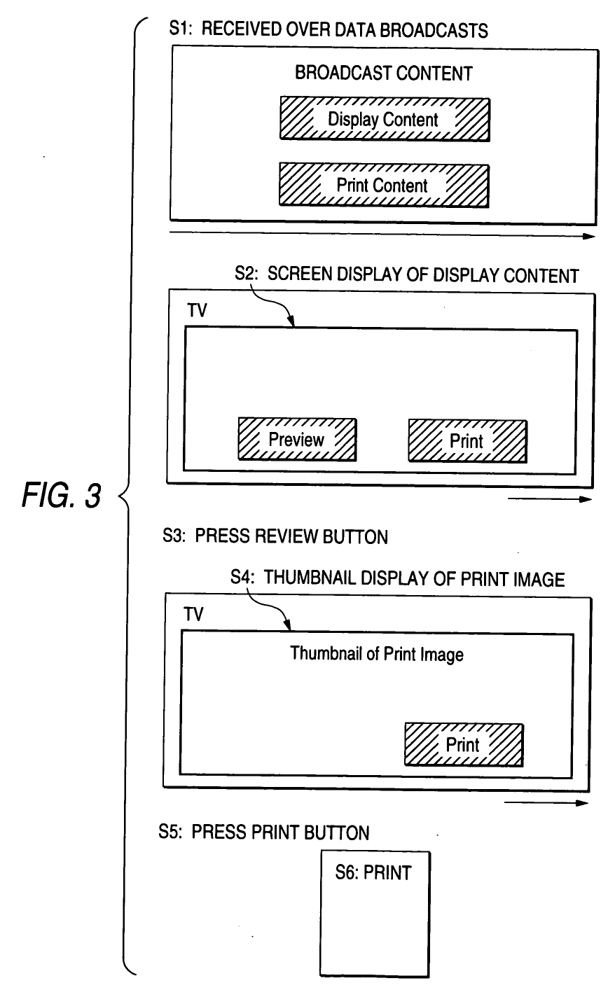

Operation of the print system 100 thus configured is described below referring to FIG. 3. FIG. 3 is a flowchart of content/operation processing in the print system 100 shown in FIG. 1. The flowchart shows a flow of transmitting broadcast data shown in FIG. 1 and performing printout based on the thumbnail data.

In FIG. 3, S1 shows a state where the display content DB and print content DB as broadcast data transmitted from the distribution server 110 are read from the display content DB (HDD) 111 and the print content DB (HDD) 113 respectively and are transmitted as broadcast data via the transmitter 116. In this practice, a print content included in the broadcast data has a thumbnail tag. To the print content is attached thumbnail file information where a URI or a file position is described or a thumbnail file.

In FIG. 3, S2 shows a state where the display data for the broadcast data is read from the HDD 137 and is displayed while the user is selecting whether to check the print image. After the operation shown in S3, print content data is read from the HDD 137, the thumbnail tag is analyzed by the content analyzer 136, and the thumbnail file is extracted and decoded to the thumbnail file by a decoder and the decoded thumbnail file is transferred to the display data generator 132 by a transfer section. S4 shows a state where the display data is transferred to the TV 133. S5 shows a state where, after checkup of the print image, a print instruction is issued from an input device such as a remote control 134 to the printer 150 on which the print image is output.

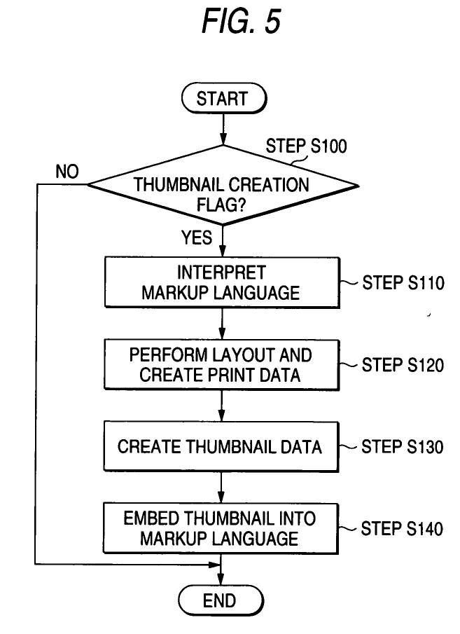

FIG. 5 is a flowchart of the processing of thumbnail creation in a host terminal such as a distribution server 110 in the print system according to Embodiment 1 of the invention. Step 100 determines a mode whether the user retains as thumbnail data the print image preset by the input device 115. In case this mode does not create a thumbnail, broadcast data not containing thumbnail data is transmitted via the transmitter 116.

In case a thumbnail creation mode is selected in step S100 and a thumbnail creation flag is set, the data of the display content is transferred to the language interpreter 112 and the markup language is interpreted (step s110). The interpreted data is transferred to the layout processor 118 in order to create a print image and the print image created 8 step S120). The layout data is transferred to the bitmap converter 119, which converts the print image (CMYK data) to bitmap data (RGB data). The bitmap-converted RGB data is converted to thumbnail data in order to reduce the volume of the data for easy processing (step S130). The thumbnail data is transferred to the print content generator 114 and file information is embedded into a thumbnail tag to create a print content (step S140).

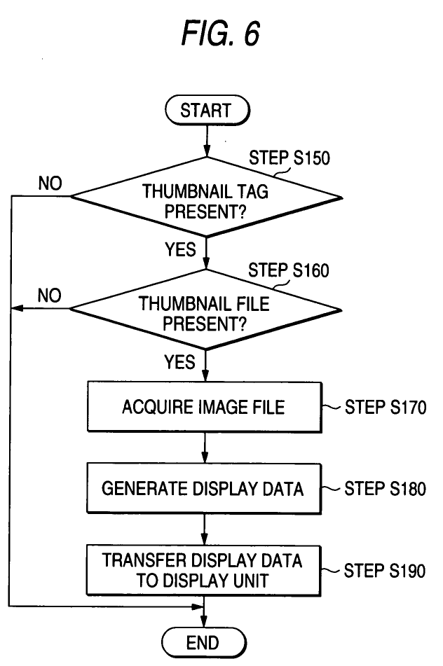

FIG. 6 is a processing flowchart of thumbnail display in the STB 130 according to Embodiment 1 of the invention. Broadcast data received by the transceiver 131 of the STB 130 is stored into the hard disk (HDD) 137, from which a print content is read into the content analyzer 136 for data analysis. In this process, it is analyzed whether the print contents contains a thumbnail tag (step S150).

In case a thumbnail tag is not detected in step S150, on a print instruction from an input device such as the remote control 134, data is output on the printer via the print data output section 138 without checkup of the print layout. In case a thumbnail tag is detected in the step S150, the content analyzer 136 acquires file information of the thumbnail file from the tag information of the thumbnail file described on the thumbnail tag and checks whether the thumbnail file is present in the HDD 137 or at the URI (Uniform Resource Identifier).

In case a thumbnail file is absent in step S160, on a print instruction from an input device such as the remote control 134, same as the step S150, data is output on the printer via the print data output section 138 without checkup of the print layout. In case a thumbnail file is present in step S160, the thumbnail file is acquired (step S170). The acquired thumbnail file is transferred to the display data generator 132 to generate display data (step S180). The generated display data is transferred to a display unit such as the TV 133 for data display (step S190).

In this way, according to Embodiment 1, by generating a content where a thumbnail file is described on a tag and receiving the content on the receiver of the STB 130, checkup of a print image on an application of a host unit such as a PC is allowed on a combination of a STB without a host unit such as a PC and a TV. A markup language can be checked at a high speed without converting the markup language to a print image on the STB 130.

While the print-only content and the thumbnail file are incorporated into an attached file to the broadcast data, such data need not necessarily be attached but some or all files of the print-only contents maybe stored in a server on the Internet with a link described in the body of a broadcast mail, or the URI to the print-only contents may be described in the header of the broadcast mail. Although an attached file to a broadcast mail may be subject to data volume limitation, this approach allows the distribution server 110 to transmit a print-only content to the STB 130 without data volume limitation.

### Embodiment 2

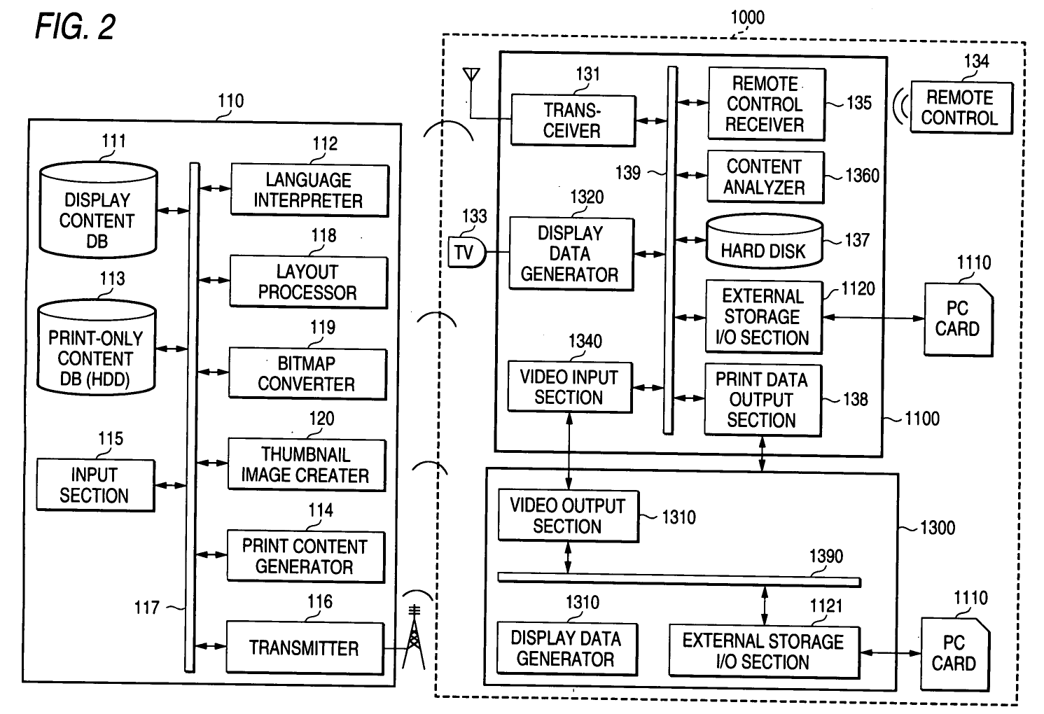

FIG. 2 is a functional block diagram showing the configuration of a print system according to Embodiment 2 of the invention. The print system 1000 receives on an STB 1100 at home a print-only content which is not displayed on a television set thumbnail tag-attached data and a thumbnail file transmitted from a distribution server 110 of a broadcast station. The print system 1000 then receives a markup language including a thumbnail tag and a thumbnail file as a print-only content from the STB 1100, interprets the markup language, and transfers the thumbnail image to a display unit. The print system 1000 comprises an external storage I/O section 1120, an external storage I/O section 1121 for performing data exchange with a PC card 1110 where a file of a markup language such as XHTML as well as a distribution server 110, STB 1100 and a printer 1300.

The print-only content refers to a content used exclusively for printing which is not displayed on a TV 133. The same components as those of the print system 1000 of Embodiment 1 have been described so that the same numerals and signs are given to these components and the corresponding description is omitted.

The PC card 1110 is an external storage storing XHTML files and image files and is not limited to a semiconductor memory such as a PC card but may be a general storage such as an SD card, a CD-R/RW or a DVD. The external storage I/O section 1120 performs input/output of XHTML files and images with the PC card. The external storage I/O section 1120 reads a file list, analyzes the read file and retains the file in order to output a content file received on the transceiver 131.

The printer 1300 receives output data from the print data output section 138 of the STB 1100. In case the PC card 1110 is inserted and it is detected that an XHTML with a thumbnail tag is stored as a result of the analysis by the external storage I/O section 1121, the printer 1300 outputs thumbnail data from a video output section 1310 to the STB 1100. The printer 1300 comprises a bus 1390.

The external storage I/O section 1121 performs input/output of XHTML files and images with the PC card 1110. The external storage I/O section 1121 reads a file list and analyzes the tag of a read file.

In case the external storage I/O section 1121 has detected that an XHTML file is stored and a thumbnail tag is found as a result of analysis, a display data generator 1310 creates display data.

The video output section 1330 transfers display data generated by the display data generator to the video input device 1340 of the STB 1100.

The bus 1390 is a parallel data transmission path in the printer 1300.

The video input device 1340 receives display data output from the printer 1300 and transfers the display data to a display data generator 1320.

A content analyzer 1360 reads data items of a file list one by one which is loaded into the external storage I/O section 1120, interprets the content, and extracts a thumbnail image from the thumbnail tag. The display data generator 1320 generates display data for displaying thumbnail images analyzed by the content analyzer 1360 and transfers the display data to a display unit such as a TV 133. The user refers to this thumbnail list to check a print image and print an XHTML file by using an input device such as a remote control 134.

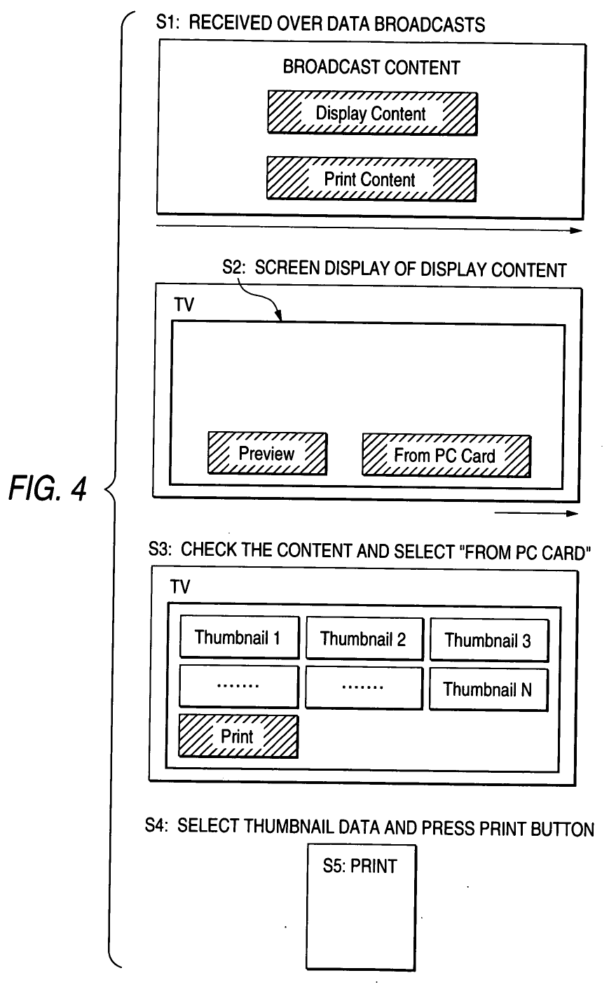

Operation of the print system 1000 thus configured is described below referring to FIG. 4. FIG. 4 is a flowchart of content/processing in the print system 1000 shown in FIG. 2. The flowchart shows a flow of displaying thumbnail data from an external storage such as a PC card 1100 and performing printing. In FIG. 4, S1 shows a state where the display content DB and print content DB as broadcast data transmitted from the distribution server 110 are read from the display content DB (HDD) 111 and the print content DB (HDD) 113 respectively and are transmitted as broadcast data via the transmitter 116. In this practice, a print content included in the broadcast data has a thumbnail tag. To the print content is attached thumbnail file information where a URI or a file position is described or a thumbnail file. S2 shows a state where the display data for the broadcast data is read from the HDD 137 and is displayed while the user is selecting whether to check the print image and whether to read thumbnail data from the external storage.

After the operation shown in S3, the markup language stored in the PC card 1110 is read into the external storage I/O section 1120, transferred file by file to the content analyzer 1360. A thumbnail tag and a thumbnail file are extracted by the content analyzer 1360 and transferred to the display data generator 1320.

In FIG. 4, S4 shows a state where the thumbnail list generated by the display data generator 1320 is transferred to the TV 133, a thumbnail data item is selected on an input device such as a remote control 134 and printing is instructed with a print image checked. S5 shows a state where the print instruction is transmitted to the printer 1300 on which the print image is output.

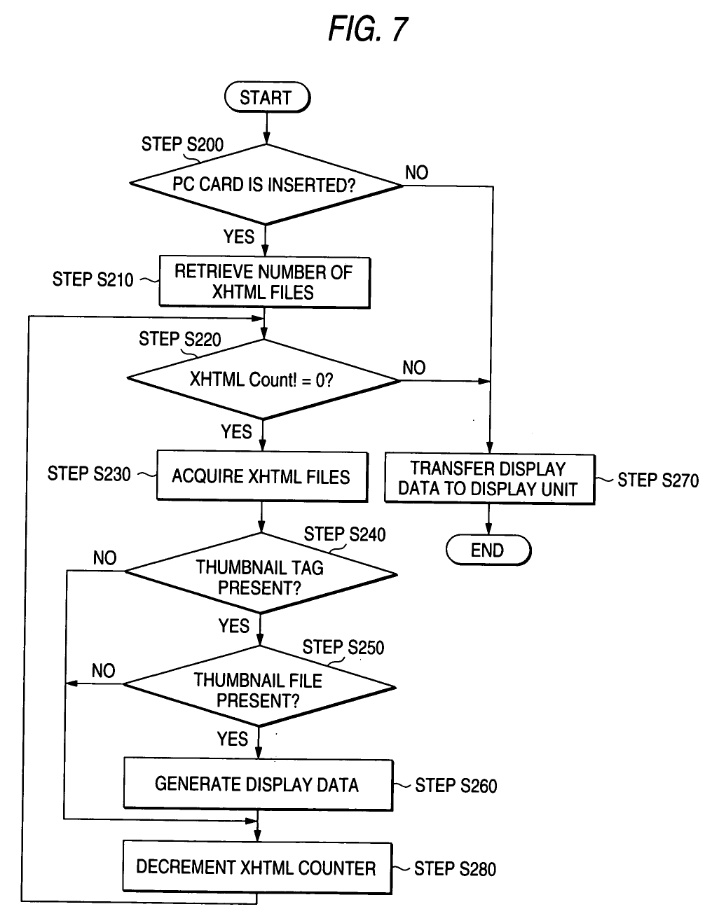

FIG. 7 is a flowchart showing the processing of extracting a thumbnail file from an external storage such as a PC card 1110 in the STB 1100 according to Embodiment 2 of the invention to display the thumbnail. Based on an input instruction from the remote control 134, a read instruction from an external storage such as a PC card 1110 is executed. An external storage I/O section 1120 checks whether the PC card 1110 is inserted by opening the directory for the PC card 1110 (step S200).

In case an attempt to open the directory has failed and whether the PC card 1110 is inserted is not checked in step S200, failure to detect the PC card 1110 is communicated to the user and execution terminates. In case whether the PC card 1110 is inserted is successfully checked in step S200, the number of XHTML files described in the directory in the PC card 1110 is retrieved (step S210).

The external storage I/O section 1120 retains the number of files. The external storage I/O section 1120 reads files one by one, transfers data to a content analyzer 1360 to decrement the file count one by one and determines whether the counter has not reached 0, that is, whether all the files stored in the PC card 1110 have been processed (step S220). In case the counter is 0 in step S220, all the files stored in the PC card 1110 have been processed, and termination of the procedure communicated to a display data generator 1320. The display data generator 1320 generates the receives thumbnail data as list data, transfers the list data to a TV 133, followed by a print instruction from an input device such as a remote control 134.

In case the counter is other than 0 in step S220, it is determined that at least one outstanding XHTML file is present and the at least one outstanding XHTML file is read from the PC card 1110 to the external storage I/O section 1120 (step S230)

A content analyzer 1360 analyzes the XHTML file transferred from the external storage I/O section 1120 and checks whether a thumbnail tag is present (step S240).

In case a thumbnail tag is not found present in step S240, the counter for the files is decremented by one (step S280) and execution returns to step S220. In case a thumbnail tag is found present in step S240, the content analyzer 1360 acquires file information of the thumbnail file from the tag information of the thumbnail file described on the thumbnail tag and checks whether a thumbnail is present in the PC card 1110 or at a URI described (step S250).

In case the presence of a thumbnail file is not checked in step S250, same as the step S240, the counter for the files is decremented by one (step S280). Execution then returns to step S220.

In case the presence of a thumbnail file is checked in step S250, the content analyzer 1360 requests the display data generator 1320 to create display data (step S260). The display data generator 1320, on receiving a termination notice from the external storage I/O section 1120, transfers the display data to the display unit (step S270).

While the top page file of a display content is a BML file in Embodiment 1 and in particular Embodiment 2, a description language need not necessarily be the BML but may be the HTML, or any other language as long as the browser in the STB can interpret the language. Similarly, a description language for a print-only content need not necessarily be the HTMLP not may be another language.

While the print system 1000 according to each of Embodiment 1 and in particular Embodiment 2 includes a hard disk 137 as a memory for string a display content and a print-only content received by the STB 130 and the STB 1100, the memory need not necessarily be a hard disk but may be another memory such as a RAM.

The invention has the advantages described below.

(1) The first aspect of the invention allows a receiver which is not equipped with a printer driver to acquire a print image thus facilitating checkup of the print layout.

(2) The second aspect of the invention shows indication information to prompt the user to display a print image.

(3) The third aspect of the invention facilitates checkup of the print image of a print content which cannot be identified from the display content.

(4) The fourth aspect of the invention facilitates checkup of the print layout.

(5) The fifth aspect of the invention facilitates printing and checkup of the print image on other equipment as well as simultaneous browsing and selection of a plurality of print images.

(6) The sixth aspect of the invention allows specification of high-resolution data independent of the capacity of the external storage without requiring a large capacity of the external storage.

(7) The seventh aspect of the invention shows allows even a receiver without a printer driver to acquire a print image thus facilitating checkup of the print layout.

(8) The eighth aspect of the invention shows indication information to prompt the user to display a print image.

(9) The ninth aspect of the invention facilitates printing and checkup of the print image on other equipment as well as simultaneous browsing and selection of a plurality of print images.

What is claimed is:

1. A print system comprising:
a receiver for receiving thumbnail data as a print image and related information indicating the link destination of said thumbnail data;
a display data generator for generating display data from said thumbnail data;
an input device for inputting a print instruction for said related data; and
a transfer section for transferring a data file pointed at by said thumbnail data in accordance with said link when said print instruction is received by said input device.

2. The print system according to claim 1, said print system further comprising a determination section for determining whether to add thumbnail data and a tag to a markup language file.

3. A print system comprising:
a receiver for receiving print data which is not displayed and thumbnail data from outside; and
an output section for outputting said print data on a printer,
wherein said output section outputs update data as print data.

4. A print system comprising:
a receiver for receiving thumbnail data and related information;
a display data generator for generating display data from said related information; and
a decoder for analyzing thumbnail data of said printer from the user which is based on said instruction information displayed and extracting thumbnail data.

5. A print system comprising:
a detachable external storage;
an information reader for reading data from said detachable external storage;
an information writer for writing data to said external storage;
a decoder for extracting thumbnail data from the file information of a file read from said external storage;
an analyzer for analyzing said file information;
a display data generator for generating display data from the extracted thumbnail data; and
transfer section for transferring said display data to a display unit.

6. The print system according to claim 5, wherein said file information includes the link file information to said thumbnail data.

7. A print thumbnail creating method comprising steps of:
determining whether to add a tag; a step of analyzing the tag of a markup language;
creating a print image to be converted to thumbnail data;
converting the print image to thumbnail data; and
adding tag information to a markup language file.

8. A print thumbnail creating method comprising steps of:
analyzing the tag of a markup language;
creating a print image to be converted to thumbnail data;
converting the print image to thumbnail data; and
adding tag information to a markup language file.

9. A print thumbnail creating method comprising steps of:
reading a file from an external storage;
analyzing the file to acquire tag information;
acquiring thumbnail data from the tag information; and
displaying the thumbnail data.
